(19) United States
(12) Patent Application Publication
(10) Pub. No.: US 2003/0188480 A1
(43) Pub. Date: Oct. 9, 2003

(54) Protective sleeve for plant pots

(76) Inventor: Carl E. Whitcomb, Stillwater, OK (US)

Correspondence Address: STREETS & STEELE, 13831 NORTHWEST FREEWAY, SUITE 355, HOUSTON, TX, 77040, US

(21) Appl. No.: 10/119,390

(22) Filed: Apr. 9, 2002

(51) Int. Cl. B32B 1/08; A01G 9/02

(52) U.S. Cl. 47/72; 428/36.1; 428/36.91

(57) ABSTRACT

A circumferential sleeve for protecting the roots of a plant in a container or pot from temperature extremes. The sleeve is formed from a flexible composite material that comprises an outer layer of a reflective material secured to an inner layer of an insulative material. A sheet of the composite material has two opposing ends that may be coupled together with various fasteners to form the circumferential sleeve or barrier around a single pot or a pot assembly. When a black or dark-colored inner layer is bonded to a white or light-colored reflective outer layer, the plant's roots are exposed to a narrower range of temperature extremes. Preferably, the sleeve is secured to a stabilized base pot adapted to receive a production pot containing soil and a plant.

### BACKGROUND OF THE INVENTION

1. Field of the Invention

This invention relates generally to an apparatus that provides a protective sleeve for protecting the roots of a potted plant. More particularly, the invention relates to a system for the above-ground production of plants in pots.

2. Background of the Related Art

The advent of growing plants above ground has brought with it many challenges. For example, the pots that are used in growing plants above ground are typically dark colored plastic to minimize the decomposition of the plastic due to ultra-violet radiation. Because the pots are dark colored, the pots tend to absorb a great deal of radiant energy from light, thereby raising the temperature of the surface of the pot as well as the contents of the pot. This raised temperature can slow plant growth and cause significant root damage.

Another challenge is that the above-ground pots typically provide little wind resistance. Accordingly, the pots may easily tip over and spill part or all of their contents under windy conditions.

One method for preventing the pots from tipping over utilizes a rebar stabilization grid to stabilize the pots to resist wind gusts. Sections of rebar are inserted into the drain holes of a base pot, typically in a crossing pattern. The sections of rebar create a large base for the base pot thereby precluding the base pot from blowing over even under significant wind loads. However, since the base pot is not as easily lifted or moved, a production pot containing a plant is placed within this base pot. Typically, the production pot and the base pot fit snuggly together to eliminate wobbling of the production pot, yet allow easy lifting of the production pot from the base pot. This solution provides great protection against wind blowing the pot over, while allowing the production pot to be easily moved. Unfortunately, this method subjects the root to the elevated temperatures that occur within the base pot.

Direct sunlight will usually only heat the roots along the side of the pot that is exposed to the direct sunlight. The roots elsewhere in the single pot would remain cooler and unaffected. In contrast, when a production pot is placed within a stabilized base pot, as described above, an air pocket is created in the region between the two pots. The entire region between the two pots is heated to substantially the same elevated temperature, even if only one side of the base pot is exposed to direct sunlight. Because the temperature within the entire air pocket is elevated, the roots within the production pot are exposed to the elevated temperatures about the entire periphery of the production pot. Consequently, plants grown in this manner will suffer more extensive root damage than normal.

Therefore, there remains a need for an apparatus and method to protect roots from being affected by temperature extremes to which they are not adapted. The apparatus should be constructed such that it withstands the harshest weather conditions and reduces the severity of the temperature fluctuations to which the plant's roots are exposed. It would be most desirable if the apparatus was compatible with stabilized pot systems, including stabilized base pot and production pot arrangements.

### SUMMARY OF THE INVENTION

The invention provides a composite material that comprises an outer layer of reflective material secured to an inner layer of insulative material adaptable for peripherally mounting around a pot assembly. In a preferred embodiment, the composite material is formed with two layers, but any number of layers may be used. Ideally, the inner layer, outer layer or the combination of layers provides sufficient stiffness that the barrier formed around the pot assembly is more or less self-supporting, yet remains flexible enough to conform to the contour of the pot assembly. The composite material can be adapted for mounting peripherally or circumferentially around a pot or a pot assembly including a base pot with a structure to preclude the base pot from tipping over and a production pot within the base pot. Alternatively, the composite material can be adapted for shielding the exterior of a pot assembly consisting solely of a base pot or solely of a production pot. In addition, the composite material can be disposed directly against the pot or pot assembly or disposed at a spaced distance to provide an air gap between the composite material and the pot or pot assembly. In a further alternative, the composite material may also form a generally circumferential sleeve, such as a generally cylindrical ring, by securing together two ends of a strip of the composite material. The two ends may be secured together by a fastener, such as a fastener selected from staples, sewing, adhesives, snaps, clasps, hook and loop fasteners, and combinations thereof.

### BRIEF DESCRIPTION OF THE DRAWINGS

So that the above recited features and advantages of the present invention can be understood in detail, a more particular description of the invention, briefly summarized above, may be had by reference to the embodiments thereof that are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of a prior art base pot and production pot assembly.

FIG. 2 is a perspective view of the present invention.

FIG. 3 is a cross-sectional side view of the composite material installed around a stabilized base pot containing a production pot.

FIG. 4 is a side view of a freestanding barrier or sleeve in accordance with the present invention.

FIGS. 5A and 5B are side views of a composite material barrier secured to a pot in a manner that restricts movement of the barrier.

### DETAILED DESCRIPTION OF THE INVENTION

The present invention provides a composite material for insulating an above-ground plant pot containing roots of a plant. The composite material is a two-layered composite that protects the roots of a plant from experiencing temperature extremes that can do sufficient damage to the roots. The two-layered material comprises an outer layer of a first material bonded or otherwise coupled or secured to an inner layer of a second material.

The primary requirements for the material of the inner layer are that the material should be resilient and insulative. The inner layer may be composed of any material that, when coupled to a layer of a reflective material on one side surface (i.e. face-to-face), will provide the resulting two-layered structure with the capacity to reflect light and insulate the plant's roots from temperature extremes. The material of the inner layer need not be porous, although it can be.

While the material of the inner layer may be made from various materials, the material is preferably a polymer fabric or matrix such as polypropylene, polyester, nylon, or other olefin. Preferably, a spun bonded needle punched fabric may be used. Preferably, the fabric has a weight greater than 3 ounce per square yard, more preferably ranging from 3 to 20 ounces per square yard, and most preferably ranging from 4 to 8 ounces per square yard. To eliminate the possibility of light and ultra-violet radiation reflecting from the face of the inner surface, the inner layer is preferably a dark color, most preferably black. Using a dark color ensures that light does not penetrate the inner layer, but rather any light penetrating the outer layer is absorbed by the inner layer before the light reaches the pot assembly.

The outer layer is a reflective material. Preferably, the outer layer material is reflective and light colored or has a reflective and light colored coating or surface. The outer layer may be composed of any material that substantially reflects light including such materials as aluminum or other metal foil, and plastic sheets. Further, the outer layer may also be formed by any material or composition, including polymers, inorganics, and composites, with polymers being the most preferred. Polymers such as vinyl, or polyolefins such as polyethylene, polypropylene, polyisobutene, poly but-1-ene, and poly 4-methyl-pent-1-ene may be used. The most recommended material is white polyethylene, which is suitable to reflect light.

The composition of the reflective material may also comprise additives. In a most preferred embodiment, the reflective material forming the outer layer comprises white polyethylene comprising UV inhibitors for stability. Additionally, the reflective material may be rigid or flexible and have any desired thickness, preferably greater than 2 mils, more preferably between 2 and 15 mils, and most preferably between 3 and 5 mils. Further, the reflective material is preferably resistant to decay, such materials resistant to decay including, without limitation, polymers such as vinyl or polyolefins.

As previously mentioned, the outer reflective material and inner insulative material may be attached, coupled, or secured together by various continuous or discrete means, including lamination, use of an adhesive, stitching, stapling, hook and loop fasteners, snaps and the like. For example, an outer white polyethylene material may be adhered to an inner fabric material, such as a spun bonded and needle punched fabric or a woven or knitted fabric. Any adhesive may be used, but preferably the adhesive is water-insoluble. Furthermore, any lamination technique may be used, provided that the lamination temperature employed does not melt the insulative material or the reflective materials. Alternatively, one of the materials may be formed directly onto the other material, such as a layer of the reflective material being sprayed over a layer of the insulative material. The materials forming the two layers may also be secured together at spaced apart intervals, for example, every inch or two or any combination thereof.

In accordance with a further embodiment of the invention, the composite material, comprising one or more of the insulative layers and one or more reflective layers, is disposed around the perimeter or circumference of a pot to form a barrier or sleeve, wherein the composite material shades the sides of the pot assembly from being irradiated by direct sunlight. The sleeve made from the composite material may have any shape or size, provided that the reflective layer faces outwardly so as to reflect radiant energy from the sun. In a preferred embodiment of the invention, the composite material is sufficiently flexible or pliable that it can form a sleeve that follows the contours of the pot that the sleeve is applied to. The most common shape for a plant pot has upright walls that are generally cylindrical or frustoconical and a base that is substantially flat. Accordingly, the sleeve will be most commonly formed in a cylindrical shape by wrapping a rectangular sheet of the composite material peripherally along the outer surface of the pot. While it may be optimal for the sleeve to make contact over the entire surface area of the pot wall, the sleeve will provide a majority of its benefits during summer conditions so long as the sleeve is disposed to shade the pot from the sun and during winter conditions so long as the sleeve is disposed to protect the pot from continual drafts of cold air. It should also be emphasized that it is not necessary for the sleeve to be fastened to the pot to provide the intended benefits.

In a most preferred embodiment, the sleeve is disposed around a pot assembly that comprises a production pot disposed within a base pot. Such sleeves should be made to fit around the base pot to reduce exposure to sunlight. It is also possible to cut the sleeve long enough to extend above the upper rim of the base pot so that the sleeve may also shield the portion of the production pot that protrudes from the base pot. Access to the upper rim of the production pot should not be significantly hampered because of the ease with which the sleeve may be pushed aside to make room for a hand to grip the rim of the pot.

In one embodiment, the sleeves are coupled to the side of a pot, preferably along an upper perimeter portion of the pot such as a rim. If the sleeve is being used in a base pot/production pot assembly, then the sleeve should be coupled to the side of the base pot, preferably along an upper perimeter portion of the pot such as a rim. The sleeve is preferably assembled in the field by stapling or otherwise coupling a sheet of the composite material to the pot. Alternatively, the sleeve may include an adhesive with a protective covering that is removed just prior to attachment to the pot. Most preferably, the two opposing edges being wrapped around the pot to form the barrier or sleeve will either be overlapped or coupled together to prevent leaving a gap there between.

In an alternative embodiment, a sleeve is not coupled to the side of the pot, but rather is formed into a freestanding sleeve that may be disposed about a single pot or a base pot. It should be recognized that the freestanding sleeve may lean against, hug or otherwise contact the pot for some amount of physical support, even though the sleeve is not directly coupled to the pot, so that the thickness and weight of the composite material can be kept to a minimum. The freestanding insulative sleeves are preferably assembled in the field by stapling or otherwise coupling a sheet of the composite material along its two opposing edges to from a continuous perimeter or curvilinear shape. Alternatively, the sleeve may include an adhesive with a protective covering that is removed just prior to attaching the two edges together.

Optionally, the upper edge of the freestanding sleeve may be folded over the top edge of the pot and stapled, thereby forming a restriction or shoulder that allows the sleeve to hang from the pot. Similarly, if the pot has a narrow diameter portion and a wide diameter portion, as will be the case with a typical frustoconical pot, then the sleeve may be gathered along the narrow diameter portion and coupled so that the upward and downward movement of the sleeve is restricted. Such a restriction of movement may be used to prevent the sleeve from collapsing to the ground and/or being blown away or misplaced. Another means of providing such a restriction includes tying a string or rubber band around the sleeve adjacent a groove or narrowed portion in the side of the pot.

The present invention further provides methods of using the composite material in horticulture and recreational gardening. Rolls of the composite material may be produced and kept available so that the material may be cut and formed into barriers, sleeves and shields having shapes and sizes desirable for a variety of applications as the need arises. Particularly, it is preferred, for purposes of economy and efficiency, that the composite material used in forming the present circumferential sleeves be made in a manner that is also suitable as a plant stem shield as that term is described in Applicant's copending U.S. nonprovisional patent application Ser. No. 10/062287, which application is incorporated by reference herein, and/or also suitable as a root growth barrier as that term is described in Applicant's copending U.S. nonprovisional patent application Ser. No. 10/075,096, which application is incorporated by reference herein.

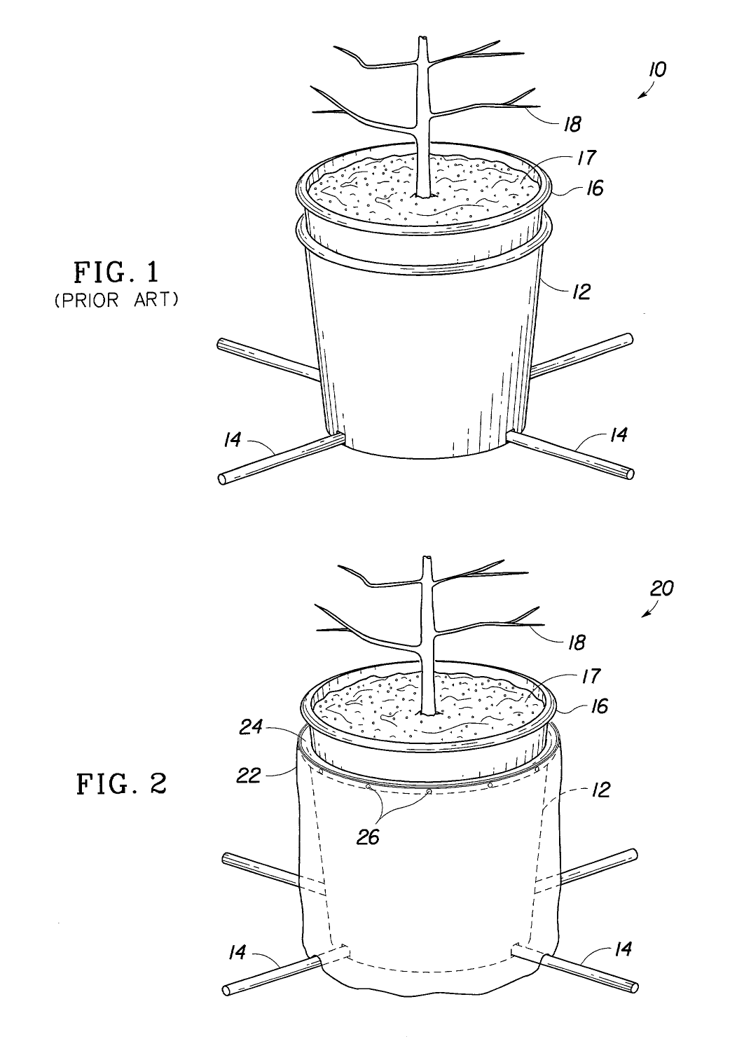

FIG. 1 is a perspective view of a prior art base pot and production pot assembly. The assembly 10 includes a base pot 12 that has been stabilized with metal bars 14 extending through the drain holes and a production pot 16 removably received in the base pot 12. It is the production pot 16 that contains the soil 17 and the plant 18. The stabilized base pot 12 serves primarily as a receptacle for securing the production pot 16 in an upright position. When the production pot needs to be moved, the production pot 16 is simply lifted out of the base pot 12.

FIG. 2 is a perspective view of an assembly of the present invention. The assembly 20 comprises a sheet of composite material 22 formed around and attached to a pot 12. The pot 12 may be a single, stand-alone pot or a stabilized base pot, as shown. In either case, the composite material 22 is wrapped around the pot 12 to form a sleeve covering substantially all the outer surface of the pot 12 and extending downward substantially to the ground. The composite material 22 is secured to the upper rim 24 of the pot 12 by fasteners 26.

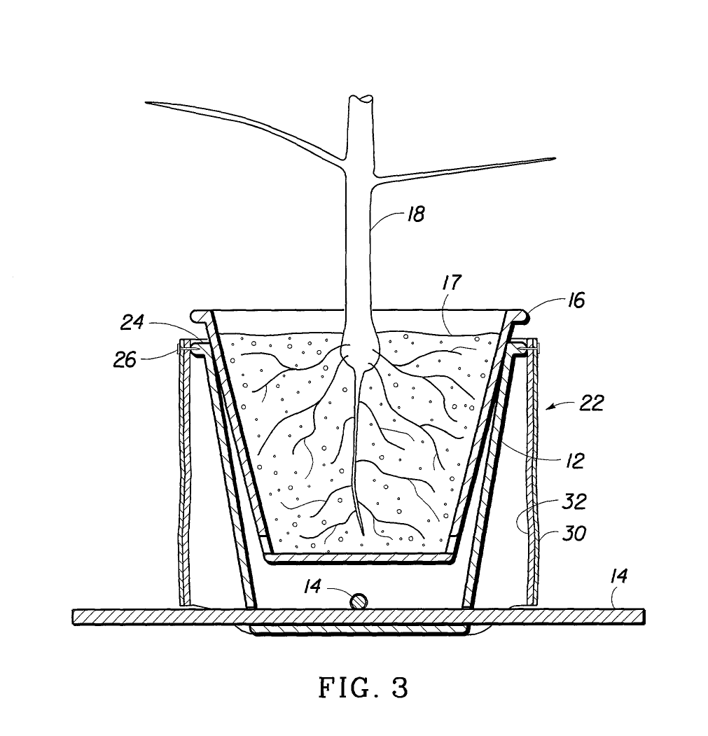

FIG. 3 is a cross-sectional side view of the composite material 22 installed around the stabilized base pot 12 containing the production pot 16. The construction of the composite material is shown in greater detail as including an outer layer 30 of reflective material secured to an inner layer 32 of insulative material. As shown, the two layers 30, 32 are secured together by laminating the outer layer 30 of reflective material, such as a polyethylene film, to the inner layer 32 of insulative material, such as spun-bonded fabric along.

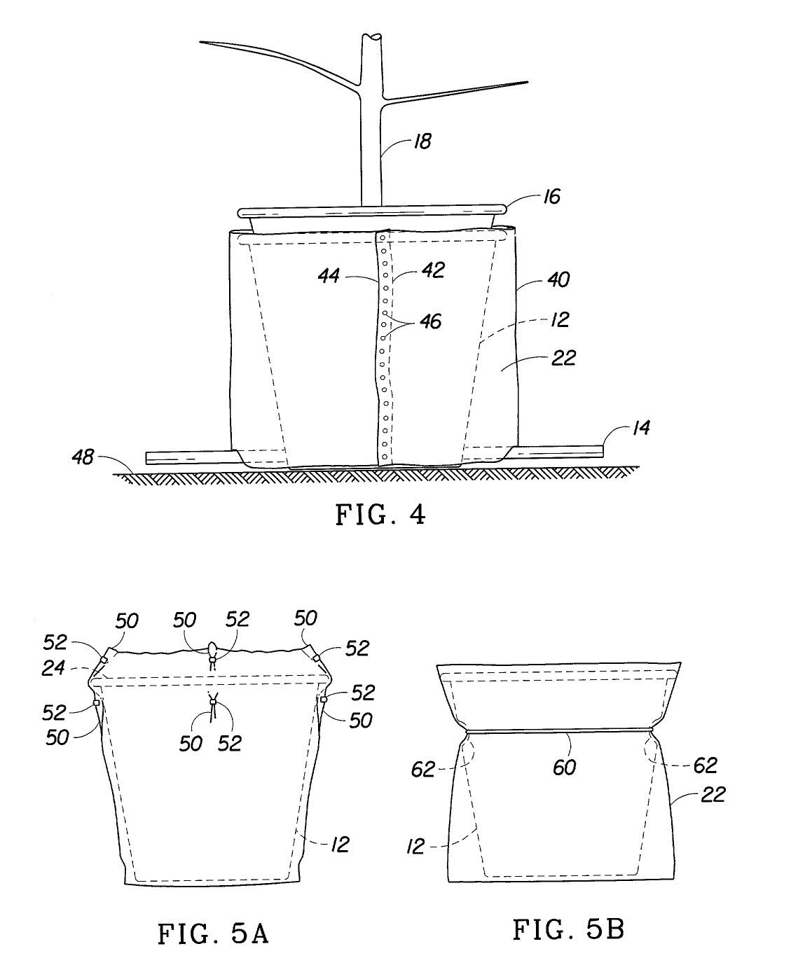

FIG. 4 is a side view of a freestanding sleeve in accordance with the present invention. The freestanding sleeve 40 is formed from the composite material 22 wrapped around the pot 12 (hidden, but shown as dashed lines) and having two opposing edges 42, 44 secured together by fasteners 46. The freestanding sleeve 40 covers the entire outer surface of the pot 12 and extends to the ground 48. Furthermore, the sleeve 40 is shown in a configuration that will contact the upper rim 24 of the pot 12 and may derive some physical support from the pot.

FIG. 5A is a side view of a composite material sleeve 22 secured to a pot 12 by gathering slack 50 in the sleeve 22 at intervals around the perimeter of the pot and securing the slack by fastening the composite material to itself with fasteners 52 so as to effectively reduce the diameter of the sleeve. By taking up such slack immediately above and/or below the upper rim 24 of pot 12, movement of the sleeve relative to the pot is restricted.

FIG. 5B is a side view of a composite material sleeve 22 secured to a pot 12 by an elastic band 60 that is received into a groove 62 that is formed in the side of the pot 12. By securing the sleeve in this manner, movement of the sleeve relative to the pot is restricted.

### EXAMPLE 1

A two-layered material was prepared by laminating a 3 mil thick sheet of white polypropylene to a 6 ounce per square yard sheet of black spun bonded fabric. The material was made into sleeves to fit around black plastic containers having a three-gallon capacity, (i.e. base pots). The sleeves were installed on one group of black base pots while another group of black base pots remained unsleeved. After allowing the temperatures to come to steady state in early summer, the outdoor air temperature measured at 101 degrees F., the average temperature along the inside wall of the unsleeved black base pots was 119 degree F., and the average temperature along the inside wall of the sleeved black base pots was 98 degrees F.

### EXAMPLE 2

The sleeves and base pots used in Example 1 were also used in this experiment. A first group of sleeved black base pots and a second group of unsleeved black base pots were measured for temperature. The experiment was conducted later in the growing season when the angle of incidence of the sun's rays relative to the side of the pots was greater. After allowing the temperatures to come to steady state, the outside air temperature measured 94 degrees F., the temperature of the inside wall of the unsleeved black base pot was 126 degrees, and the temperature of the inside wall of the sleeved black base pot was 94 degrees.

### EXAMPLE 3

The sleeves and base pots used in Example 1 were also used in this experiment. A first base pot that had a sleeve and a second base pot that did not have a sleeve were measured for temperature. Both pots were placed directly on the ground outside. After allowing temperatures to come to steady state, the outside air temperature was 7 degrees F., the temperature of the inside wall of the unsleeved black base pot was 10 degrees, and the temperature of the inside wall of the sleeved black base pot was 21 degrees.

The term “comprising” means that the recited elements or steps may be only part of the apparatus or method and does not exclude additional unrecited elements or steps.

It will be understood that certain combinations and sub-combinations of the invention are of utility and may be employed without reference to other features in sub-combinations. This is contemplated by and is within the scope of the present invention. As many possible embodiments may be made of this invention without departing from the spirit and scope thereof, it is to be understood that all matters hereinabove set forth or shown in the accompanying drawings are to be interpreted as illustrative and not in a limiting sense.

I claim:

1. An apparatus comprising:
a circumferential sleeve adapted for shielding the exterior of a plant container from direct sunlight, wherein the sleeve comprises an inner layer of thermal insulation material coupled to an outer layer of a reflective material.

2. The apparatus of claim 1, wherein the reflective material is an ultraviolet-tolerant white polypropylene.

3. The apparatus of claim 1, wherein the insulative material is resilient.

4. The apparatus of claim 1, wherein the reflective material is resilient.

5. The apparatus of claim 1, wherein the reflective material is also water or chemical impermeable.

6. The apparatus of claim 1, wherein the sleeve has two opposing ends coupled together by a fastener selected from a staple, sewing, adhesive, snap, clasp, hook and loop fastener, and combinations thereof.

7. The apparatus of claim 1, wherein the insulative material comprises a porous fabric.

8. The apparatus of claim 7, wherein the porous fabric has a weight between 4 and 8 ounces per square yard.

9. The apparatus of claim 7, wherein the porous fabric is selected from a spun bonded/needle punched fabric, a woven fabric, a knitted fabric, and combinations thereof.

10. The apparatus of claim 7, wherein the porous fabric is selected from polyester, polypropylene, cotton, and combinations thereof.

11. The apparatus of claim 7, wherein the porous fabric is black or gray.

12. The apparatus of claim 1, wherein the reflective material is selected from a metal sheet, a metal foil, a polymer sheet, and combinations thereof.

13. The apparatus of claim 12, wherein the polymer sheet is selected from polyethylene, polypropylene, and polyvinylchloride.

14. The apparatus of claim 1, wherein the reflective material is white and the insulative material is black or gray.

15. The apparatus of claim 2, wherein the ultraviolet-tolerant white polypropylene has a thickness greater than 2 mils.

16. The apparatus of claim 2, wherein the ultraviolet-tolerant white polypropylene has a thickness between 2 and 15 mils.

17. The apparatus of claim 2, wherein the ultraviolet-tolerant white polypropylene has a thickness between 3 and 5 mils.

18. The apparatus of claim 7, wherein the porous fabric has a weight between 3 and 20 ounces per square yard.

19. The apparatus of claim 7, wherein the porous fabric has a weight greater than 3 ounces per square yard.

20. The apparatus of claim 1, wherein the sleeve is substantially cylindrical and is open at the top and bottom of the sleeve.

21. The apparatus of claim 1, further comprising:
means for fastening the sleeve to the plant container.

22. An apparatus comprising:
a stabilized base pot;
a plant production pot removably received within the base pot; and
a circumferential sleeve adapted for shielding the exterior of the base pot from direct sunlight, wherein the sleeve comprises an inner layer of insulative material coupled to an outer layer of a reflective material.

23. The apparatus of claim 22, wherein the reflective material is an ultraviolet-tolerant white polypropylene.

24. The apparatus of claim 22, wherein the insulative material is resilient.

25. The apparatus of claim 22, wherein the reflective material is resilient.

26. The apparatus of claim 22, wherein the reflective material is also water or chemical impermeable.

27. The apparatus of claim 22, wherein the sleeve has two opposing ends coupled together by a fastener selected from a staple, sewing, adhesive, snap, clasp, hook and loop fastener, and combinations thereof.

28. The apparatus of claim 22, wherein the insulative material comprises a porous fabric.

29. The apparatus of claim 28, wherein the porous fabric has a weight between 4 and 8 ounces per square yard.

30. The apparatus of claim 28, wherein the porous fabric is selected from a spun bonded/needle punched fabric, a woven fabric, a knitted fabric, and combinations thereof.

31. The apparatus of claim 28, wherein the porous fabric is selected from polyester, polypropylene, cotton, and combinations thereof.

32. The apparatus of claim 28, wherein the porous fabric is black or gray.

33. The apparatus of claim 22, wherein the reflective material is selected from a metal sheet, a metal foil, a polymer sheet, and combinations thereof.

34. The apparatus of claim 22, wherein the reflective material is a polymer sheet selected from polyethylene, polypropylene, and polyvinylchloride.

35. The apparatus of claim 22, wherein the reflective material is white and the insulative material is black or gray.

36. The apparatus of claim 23, wherein the ultraviolet-tolerant white polypropylene has a thickness greater than 2 mils.

37. The apparatus of claim 23, wherein the ultraviolet-tolerant white polypropylene has a thickness between 2 and 15 mils.

38. The apparatus of claim 23, wherein the ultraviolet-tolerant white polypropylene has a thickness between 3 and 5 mils.

39. The apparatus of claim 28, wherein the porous fabric has a weight between 3 and 20 ounces per square yard.

40. The apparatus of claim 28, wherein the porous fabric has a weight greater than 3 ounces per square yard.

41. The apparatus of claim 22, wherein the sleeve is fastened to the base pot.
